(19) United States
(12) Patent Application Publication
(10) Pub. No.: US 2014/0354676 A1
(43) Pub. Date: Dec. 4, 2014

(54) HAIR COLOURING DEVICE AND METHOD

(71) Applicant: WISIMAGE, Clermont Ferrand (FR)

(72) Inventor: Christophe Blanc, Theix (FR)

(73) Assignee: WISIMAGE, Clermont Ferrand (FR)

(21) Appl. No.: 14/371,597

(22) PCT Filed: Jan. 11, 2013
(86) PCT No.: PCT/FR2013/000013

§ 371 Date: Jul. 10, 2014

(30) Foreign Application Priority Data
Jan. 13, 2012 (FR) 1200104

(51) Int. Cl. G06T 11/60; G06T 11/00; G06F 3/041; G06F 3/0484

(52) U.S. Cl. CPC G06T 11/60; G06F 3/04842; G06T 11/001; G06F 3/041
USPC 345/594

(57) ABSTRACT

The invention relates to a hair colouring device and method. The method can be used to generate a hair colouring simulation using a target image of a user, said method comprising the following steps: an image module receives data from a target image to be processed; an interface module generates a user interface, allowing reception of the selection of at least one colouring zone identification point; after reception of the selection data, the interface module sends the data to a hair mask segmentation module; and the hair mask segmentation module extracts the zone corresponding to the user's scalp.

### TECHNICAL FIELD OF THE INVENTION

The invention relates to a method for extraction and virtual colouring of a capillary template of a target person in approximately real time using information on the arrangement of the capillary template provided by the user using a digital medium having or connected to a touch screen.

PRIOR ART

Several types of digital technology are currently known that allow a user to simulate a make-up, or to test a make-up virtually using a digital photograph of the face and tools for selecting and applying colours. Despite the multitude of solutions made available to users, there are very few solutions that enable realistic results to be obtained. There are a number of reasons for the imperfections in the solutions offered. Most frequently, the difficulty in accurately detecting the various zones of the face to be made up is a source of several problems.

For applications that also aim to take into consideration the simulation of colouring hair, in addition to the difficulty of delimiting the target zone to be coloured, other difficulties make it particularly hard to simulate colouring in an accurate, reliable and realistic manner. Thus, the very strong colour gradient in very small zones caused by the large number of hairs, the problems produced by highlights, and the fact that a single hair often has different colorimetric features, are just some of the problems to be overcome in performing such simulations.

There are several approaches to virtual hair colouring on a digital photograph. They can be divided into four groups.

The first group is based on detecting the face of the target person automatically (no information or limit is added to the detection algorithm) or semi-automatically (a template with the position of certain facial elements is used to restrict the position of the face of the target person in the digital photograph). The objective is to detect and model the face via different characteristic points and an outline of the face. As soon as this information is determined, a virtual wig is “placed” on the head of the target person. This method allows only a predefined head of hair to be put in place and not a virtual hair colouring of the target person.

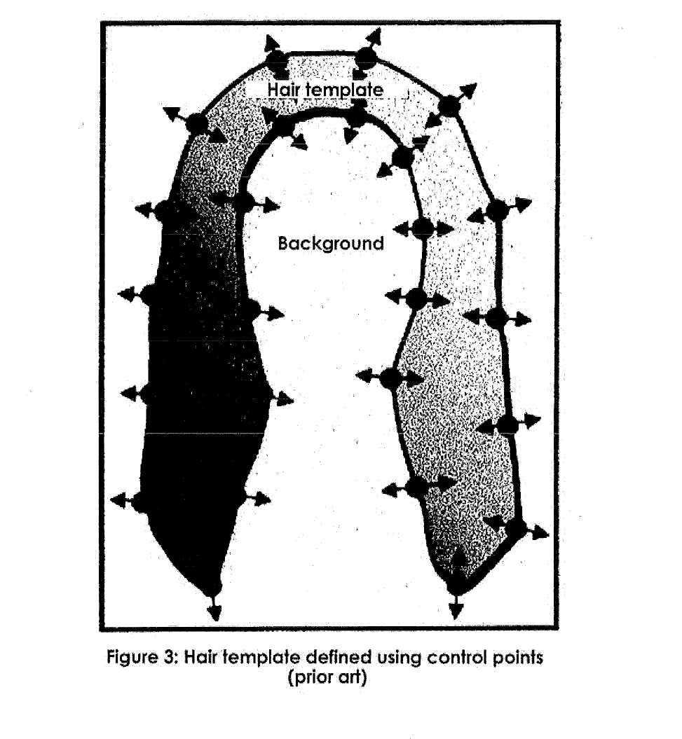

The second group is based on the use of a hair template that can either be predefined, or defined by the user as shown in FIG. 3. This hair template is defined/outlined via several points connected to one another by straight lines. Where this hair template is predefined, the user will have to move the points defining the hair template, using a cursor, in order to adapt this generic template to the head of hair of the target person. In the second case, the user must use a cursor to manually define all the points defining the person's hair template. As soon as the hair template is well-adapted to that of the target person, hair colouring is applied in the zone defined by these different points. This method is demanding for the user, because he has to define the hair template completely or partially. Furthermore, this definition must be as accurate as possible so that the hair colouring is situated on all the hairs of the target person only and not on part of the background or the face.

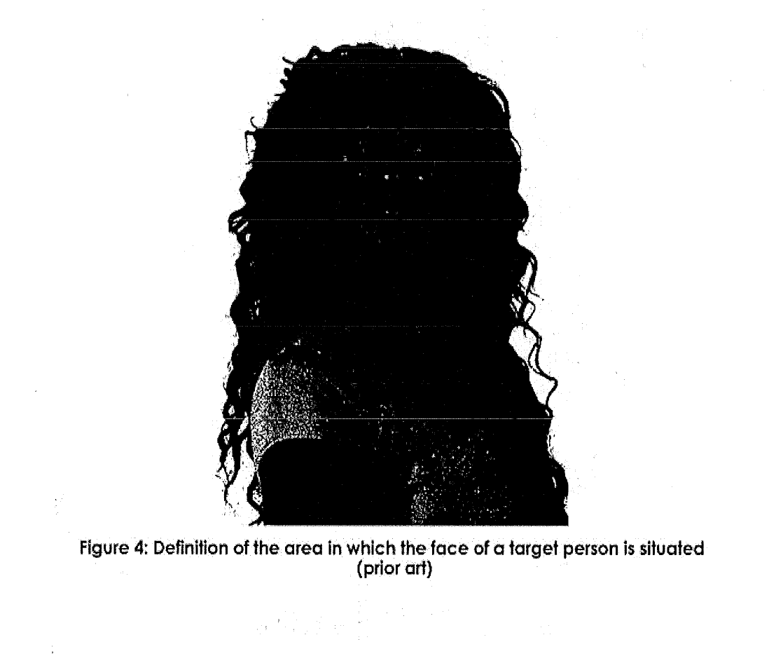

The third group is based on a hair segmentation approach. For the existing methods, the objective is to extract the hair template semi-automatically. However, at present, the user has to perform several demanding actions. First, he must take a photograph of the upper part of his body, preferably centred with a uniform background. Secondly, using a mouse, he must position a rectangle inside which his face is situated (cf. FIG. 4). Thirdly, again with the mouse and without any user-friendly interface, he must place points on the image on his hair and on the background. Although this method is semi-automatic, its use remains very demanding for the user because he must perform several actions, otherwise the results obtained when the hair is coloured will be poor.

The last type of approach is based on touch-screen technology. After taking a digital photograph and storing it, the user must “colour” the zone in which the hairs are situated, using his finger and the touch screen. This solution is minimalist because no automatic or semi-automatic detection of the hair template is performed. The hair colouring will be applied only in the zones defined by the passage of the user's finger over the tactile interface. This solution therefore has two major disadvantages: the user must colour the whole head of hair manually and the colour is applied uniformly to the coloured parts, without any artificial intelligence. None of the currently existing solutions make it possible to take into account all the technical difficulties set out above, simply, quickly, reliably and effectively. There is therefore currently a major need to find an effective solution to these numerous problems.

### DESCRIPTION OF THE INVENTION

With the aim of avoiding the disadvantages of the approaches described in the paragraph above, the invention provides for:
a step of making available to the user an interface for choosing the required zone for colouring the hair: during this step, as shown in FIG. 5, the user uses the interface and the selection tool placed at his disposal to select the hair zone. Several modes of selection can be offered, depending on the circumstances. In the example shown, the user selects a plurality of points by tracing at least one line in the hair zone. This variant is particularly advantageous because it allows several points to be taken into consideration. As, in many heads of hair, the colour varies noticeably from one point to another, this approach makes it possible to indicate a whole series of colour data to be taken into consideration. In a simplified variant, the user selects at least one point in the zone to be coloured. Also in a variant, the method makes available an interface that enables the user to indicate the zone surrounding the head of hair, in the background of the subject.
The method makes it possible to segment the capillary template on the basis, firstly, of information obtained previously and, secondly, of information provided by the user. The method therefore makes provision for the receipt of colouring data corresponding to the points and/or zones selected by the user. This addition of information enables the algorithm for segmenting the capillary template to be initialised in an optimal manner.
Advantageously, provision is made for a step that makes it possible to look for the face of the target person in the image. Using this data that locates the face of the target person, the image is reframed and resized so that it is centred on the face. This method therefore enables the limitation on the position of the face during the photography step to be reduced.

By virtue of this automatic method, it is no longer necessary to define the capillary template manually or to oblige the user to produce a photograph with severe limitations on the position of his face in the image. The only action that he has to perform is to define the points describing the arrangement of the hair of the target person, using a “user-friendly” interface.

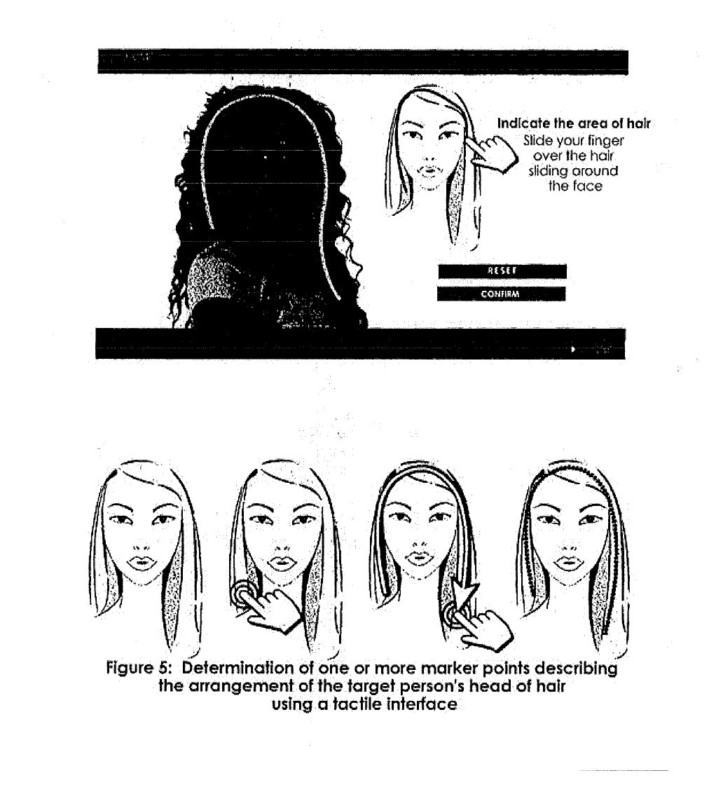

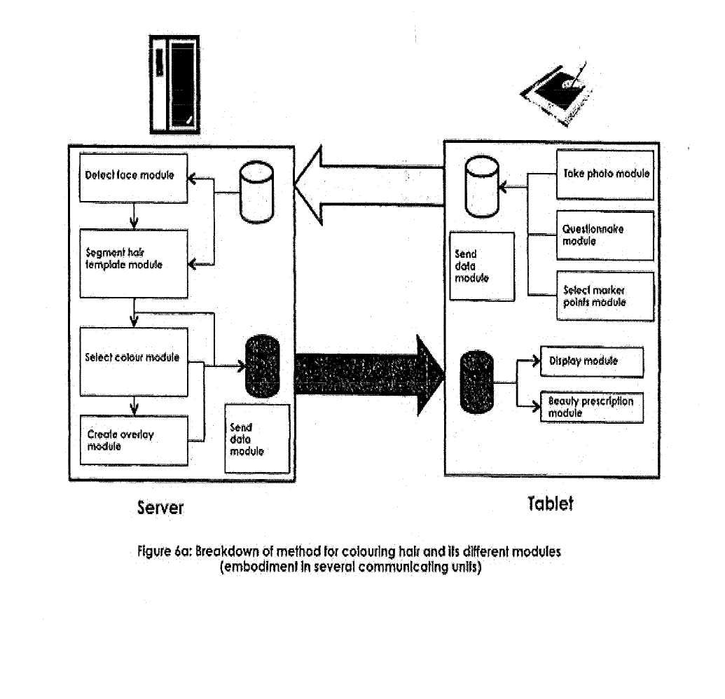

In an embodiment illustrated in the drawings, the automatic method of hair colouring based on a tactile interface is shown in FIG. 6. It is based on the use of a tactile interface (monitor, mobile phone or tablet computer) associated with a server that performs the calculations necessary to locate the face of the target person, and to segment and colour the capillary template. The communication between the two entities is based on known means such as a WiFi or WiMax protocol or a cable where a touch screen is used with a PC or server, or any other means allowing data to be exchanged.

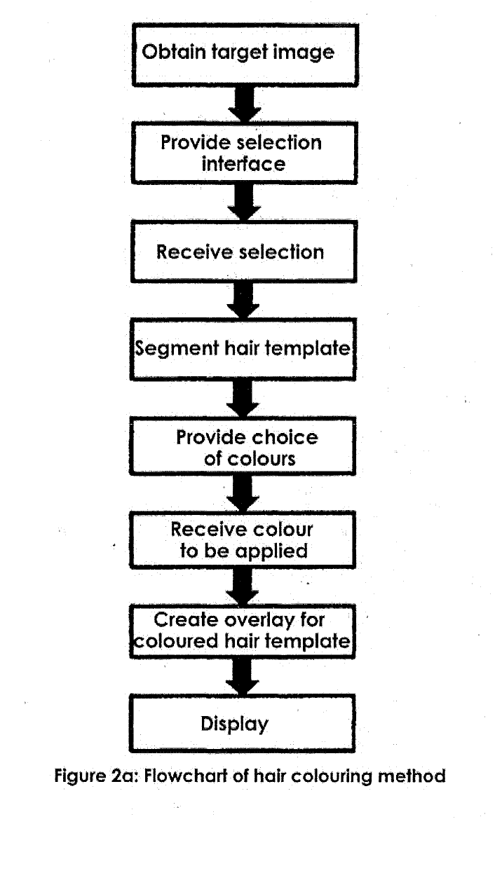

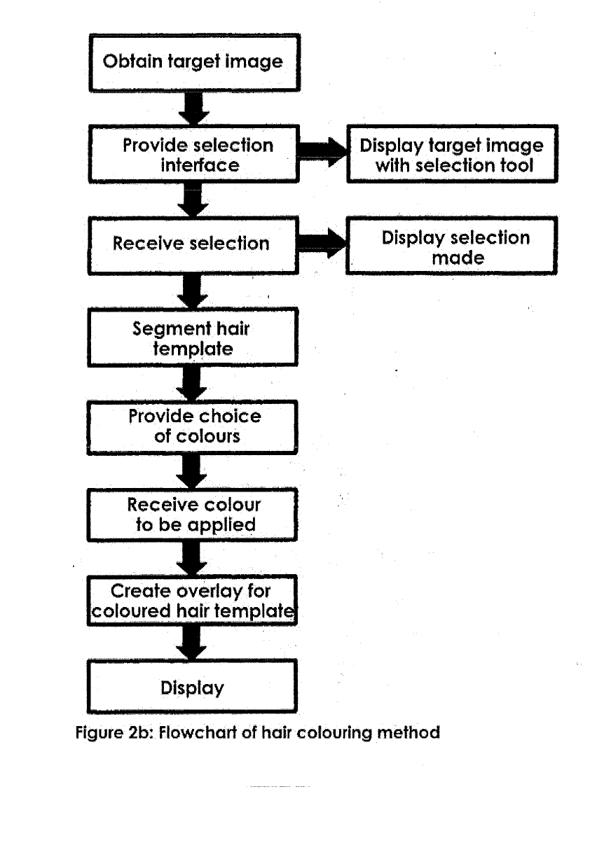

To illustrate the method according to the invention, the method is broken down into different steps shown in FIG. 2. These steps are described with reference to the modules required to perform these steps.

### a) Step 0: Obtain an Image of the Target Person

Upstream of the method, a photo of the head of the target person can be produced via two different approaches. The user uses either a remote digital camera, or the camera incorporated into the tactile medium such as a tablet computer (keyboardless portable computer with a touch screen and intuitive user interface such as, for example, the products marketed under the name “iPad”) or a smartphone (“iPhone” for example). A pre-existing image can also be used.

In the case where the photograph is based on the use of a tablet or a smartphone, the user can use the Take Photo module. In this way, he is guided by the presence of a target (circle or hatched area) on the screen used as an interface which enables him to produce an optimum photo, ensuring the proper functioning of the application and simplified use from his point of view.

### b) Step 1: Questionnaire (Optional)

By virtue of an interactive graphic interface provided by the tactile medium, it is possible to ask the user questions about his hair type and about the colour that he wishes to apply.

During step 5, this information makes it possible to determine the colour to be applied to the hair that most closely corresponds to the user's wishes. This step enables the hair colouring to be customised and the user's expectations to be more easily met.

### c) Step 2: Manually Select the Head of Hair

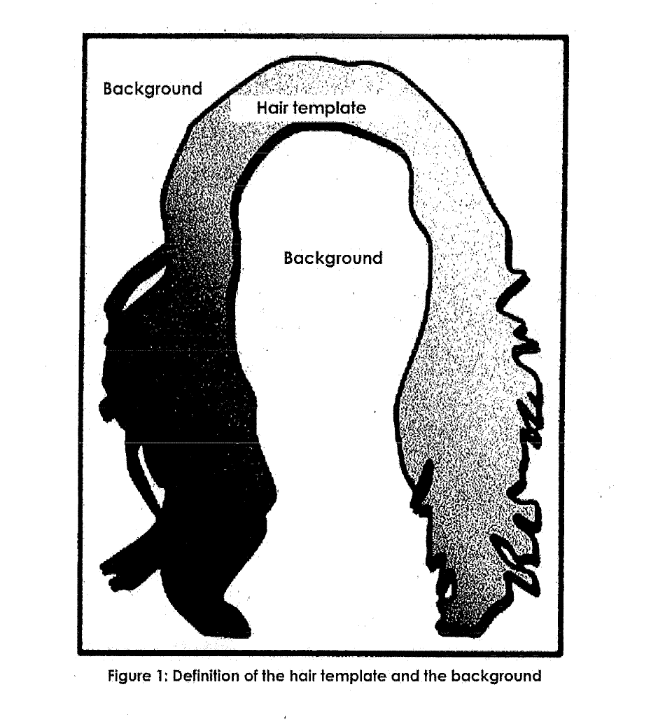

This step corresponds to the determination of the arrangement of the hair by the user of the invention. It is preferably based on the use of a tactile interface. By passing a finger over the hair of the target person, as shown in FIG. 5, the user selects one to a plurality of points describing the arrangement of the hair, a zone described as the foreground in FIG. 1. This operation can be repeated in an identical manner in order to describe the arrangement of the zones making up the background shown in FIG. 1. Once the operation is complete, a validation enables the information (marker points and image of the target person) to be sent to the server that will perform steps 3 to 5.

Essentially, this step is based on three modules (cf. FIG. 6):
The Select Marker Points module that enables the points described by the passage of the user's finger over the tactile medium to be received and recorded.
The Display Results module, enabling the points determined by the user to be displayed on the touch screen in real time, superimposed on the image of the target person.
The Send Data module which, once the points have been selected and validated, enables the image and the marker points to be sent to the server,

### d) Step 3: Detect the Face and Resize the Image

This step corresponds to a search for the face in the image, using an image processing algorithm such as that based on an “AdaBoost” learning method with Haar wavelets as descriptor. This algorithm runs through the entire image to look for thumbnails of pixels, described by the wavelets, identical to the information obtained with the learning and provided a priori. As soon as the comparison is positive, the face of the target person is located in the image.

Based on this detection, the method performs two operations. It automatically chooses points belonging to the detected face that are identified as belonging to the background. It redimensions and recentres the image on the face of the target person.

This set of actions is advantageously implemented by the Detect Face module (cf. FIG. 6).

The purpose of using this methodology is to avoid restricting the position of the face of the target person to the centre of the image when the photograph is taken.

### e) Step 4: Segment the Capillary Template

This automatic segmentation of the hair template is advantageously performed by an image-processing algorithm known as “GrabCut”. This algorithm runs through the whole image looking for pixels that are of the same intensity as the pixels associated with the background or with the hair template that are provided as input. The objective is to label all the pixels of the image either as background, or as hair template. Then, the algorithm seeks to optimise a boundary between the two classes of pixels obtained while still being based on the strict limits given as input. In other words, the algorithm seeks the best compromise between the two zones using highly restrictive information provided as input.

Thus, the arrangement of the head of hair described by the marker points positioned by the user (hair template in FIG. 1) and the arrangement of the facial skin obtained with the points detected during step 4 (part of the background in FIG. 1) are thus used as input to the algorithm (Segment Hair Template module). Because this initialisation is correct (strict limits), the algorithm detects the parts of the image of the target person that match this arrangement more rapidly and more accurately.

Finally, the receipt of colorimetric data about the background zone enables the points for which the colorimetric data is identical or almost identical to the data received for that zone to be excluded from the zone to be coloured. Then, the receipt of colorimetric data about the facial zone also enables the points for which the colorimetric data is identical or almost identical to the data received for that zone to be excluded from the zone to be coloured. On exiting this module, we will obtain a zone corresponding to the hair template with the arrangement identified by the user of the invention.

### f) Step 5: Select the Colour

This step breaks down into two separate parts. First, the colour of the hairs contained within the hair template is determined. With this value and any information obtained during step 1, the method automatically determines a plurality of possible hair colouring colours that correspond both to the current hair template and to the user's expectations (Select Colour module shown in FIG. 6).

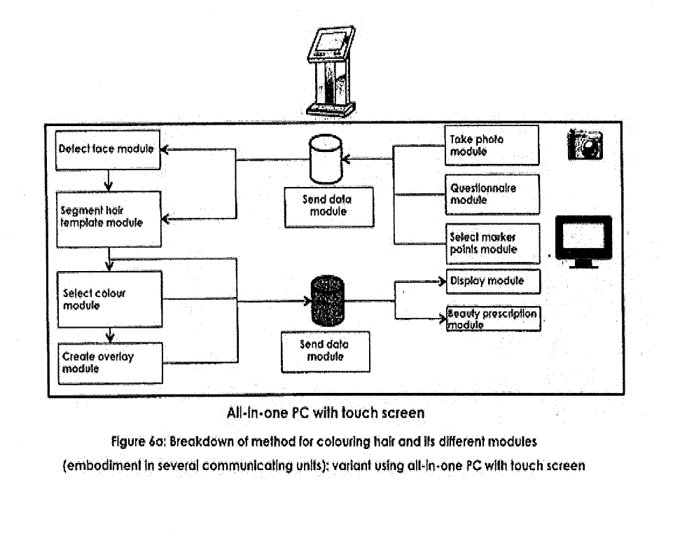

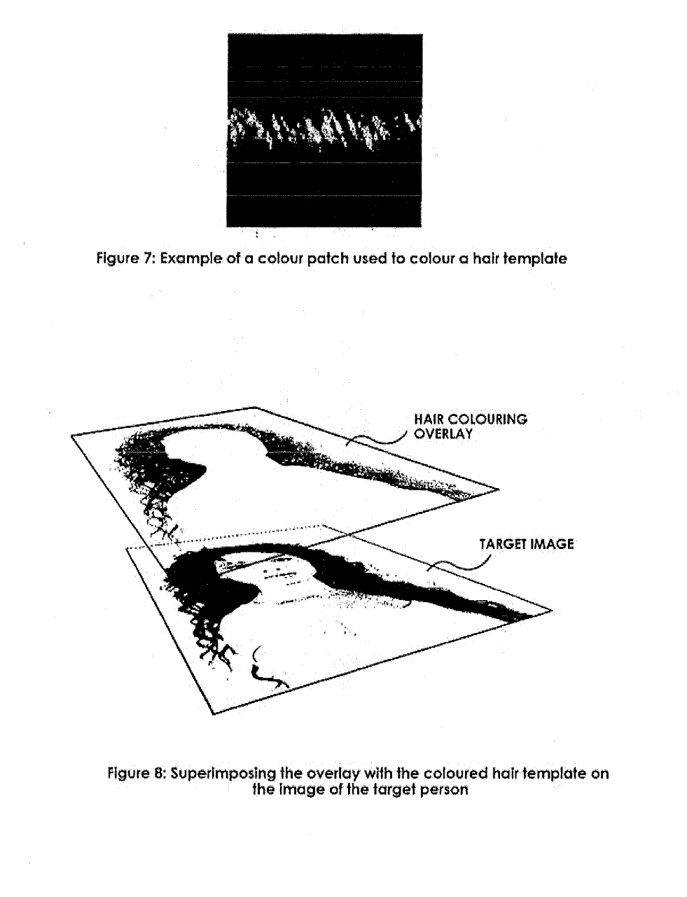

These colours are represented by patches like the example shown in FIG. 7. These patches represent a palette of the same colour with different brightnesses, tones and degrees of contrast. These items of information make it possible, during step 6, to retain the different highlights that can be seen on the hair template of the target person in the original image.

### g) Step 6: Create an Overlay of the Coloured Capillary Template

This step corresponds to the creation of a hair template using one of the patches selected at step 5. This function is implemented by the Create Template function. The objective of this step is to obtain a uniform and realistic colouring of the hair template. In order to do this, it is necessary to perform several consecutive processing steps applied firstly to the colour patch selected during step 5, and secondly to the hair template extracted from the image of the target person during step 4.

This step breaks down into several separate parts. In a first part, the colour patch and the hair template are converted into histograms defined on the basis of a colorimetric criterion. For optimum rendering of the colour, these histograms must be situated in the same value area according to the colorimetric criterion. If this is not the case, the colours of the hair template of the target person are transposed into the definition area of the colour patch. Then, in a second part, the colours of the chosen patch are all extracted, the duplicates (pixels with identical characteristics) being eliminated. Next, these pixels are classified according to colorimetric criteria. In a third part, the same method of sorting pixels is applied to the hair template. During a final operation, the sorted pixels from each graphic entity are correlated using the colorimetric criterion employed previously.

Starting from the hair template extracted during step 4, all the pixels are coloured using the chosen patch. However, this colouring is not uniform. It adheres to the existing highlights (contrast, tone and intensity of the different pixels) in the original hair template. By virtue of this method, the final rendering of the hair colouring is realistic.

In the example shown, this step is the last step performed by the server. As soon as the overlay is created, the server sends the information to the tactile medium.

### h) Step 7: Screen Display

After receipt of the data, the tactile medium displays the result of the capillary colouring, superimposing the coloured overlay on the original image of the target person (cf. FIG. 8).

The user can, after looking at the initial result, select a different colour. The tactile medium redefines an overlay and displays the result, superimposing it on the image of the target person (cf. FIG. 8).

### i) Step 8: Produce a Beauty Prescription

Via a graphic interface, this step produces a summary of the preceding operations performed by the invention:
A display of the image of the target person with the chosen hair colouring;
A list of the different products necessary for the hair colouring;
Explanations, based on diagrams, as to how to perform the hair colouring correctly.

These prescriptions are printed at the end in PDF format.

The method and the device according to the invention are illustrated and described above by a system with two separate entities. Several variants are also possible without departing from the scope of the invention. For example, an all-in-one PC (with screen, microprocessor and other elements incorporated into a single unit) can also be used to implement the invention. In another variant, a touch tablet with sufficient computing capacity can also be used.

In another variant, the tactile interface can be replaced by a movable cursor of a known type activated remotely by a mouse, a numeric keypad, or any other known means for displacement. In such an example, the selection made by the user's finger in the description above is replaced by a selection made by a movement of the cursor in the relevant zone to be selected.

Finally, whether with a movable cursor that can be activated remotely or with a tactile interface, the zone to be coloured can be selected by one or preferably by a plurality of discrete points included in the zone to be coloured.

The implementation of the different colouring device modules described above is advantageously effected via instructions or commands, enabling the modules to perform the operation(s) specifically planned for the module concerned. The instructions can be in the form of one or more than one piece of software or software module implemented by one or more than one microprocessor. The module or modules and/or the piece(s) of software are advantageously provided in a computer program product comprising a recording unit or recording medium useable by a computer and having a computer-readable programmed code incorporated into said unit or medium, enabling a piece of application software to be executed on a computer or other microprocessor device, such as a tablet with a touch screen.

1. Capillary colouring method enabling a hair colouring simulation to be generated, based on a target image of a user, comprising the steps in which:
an image module receives the data from a target image to be processed;
an interface module generates a user interface allowing a selection of at least one colouring zone identification point to be received;
after receiving selection data, the interface module sends the data to a capillary template segmentation module;
the capillary template segmentation module extracts the zone corresponding to the user's head of hair.

2. Capillary colouring method according to claim 1, in which an interface module provides a choice of colouring for the user and receives a colouring selection.

3. Capillary colouring method according to claim 2, in which a template creation module generates a template for application to the target image and displays the coloured image.

4. Capillary colouring device for implementing the method according to claim 1, comprising:
an image module capable of receiving the data about a target image to be processed;
an interface module capable of generating a user interface allowing a selection of at least one colouring zone identification point to be received;
the capillary template segmentation module capable of extracting the zone corresponding to the user's head of hair.

5. Capillary colouring device according to claim 4, further comprising a template creation module capable of generating a template for application to the target image and displaying the coloured image.

6. Capillary colouring device according to claim 4, in which the interface module is also adapted to provide the user with a choice of colouring and to receive a colouring selection
